(19) United States
(12) Patent Application Publication
(10) Pub. No.: US 2021/0311540 A1
(43) Pub. Date: Oct. 7, 2021

(54) POWER-SAVING POWER ARCHITECTURE FOR INTEGRATED CIRCUITS SUCH AS MICROCONTROLLERS

(71) Applicant: Silicon Laboratories Inc., Austin, TX (US)

(72) Inventors: Rex Tak Ying Wong, Singapore (SG); Ricky Setiawan, Singapore (SG); Hua Beng Chan, Singapore (SG); Yushan Jiang, Singapore (SG); Pio Balmelli, Arogno (CH)

(73) Assignee: Silicon Laboratories Inc., Austin, TX (US)

(21) Appl. No.: 16/841,138

(22) Filed: Apr. 6, 2020

(51) Int. Cl. G06F 1/3237; H02M 1/00; G06F 1/3234; G06F 1/28; G06F 1/3296

(52) U.S. Cl. CPC G06F 1/3237; H02M 1/00; G06F 1/3275; H02M 3/07; G06F 1/3296; H02M 2001/0045; G06F 1/28

(57) ABSTRACT

An integrated circuit includes a first plurality of circuits receiving a first internal power supply voltage, a first regulator receiving an external power supply voltage and supplying the first internal power supply voltage at a first rated power in response to the external power supply voltage when the integrated circuit is in an active mode, a second regulator receiving the external power supply voltage for supplying the first internal power supply voltage at a second rated power less than said first rated power in response to the external power supply voltage when the integrated circuit is in a low power mode, and a controller controlling a transition of the integrated circuit between the active mode and the low power mode. The controller activates all of the first plurality of circuits in the active mode, but only a subset of them while keeping remaining ones inactive in the low power mode.

### FIELD

The present disclosure relates generally to integrated circuits, and more particularly to internal power supply architectures for integrated circuits such as microcontrollers (MCUs).

### BACKGROUND

Microcontrollers (MCUs) are integrated circuits that combine the main components of a computer system, i.e. a central processing unit (CPU), memory, and input/output (I/O) peripheral circuits, on a single integrated circuit chip. Modern MCUs are useful in a wide variety of consumer products such as mobile phones, household appliances, automotive components, and the like because of their low-cost. Typical MCUs combine different types of circuits that have different power supply requirements on a single chip. For example, digital circuits implemented using complementary metal-oxide-semiconductor (CMOS) transistors require only a low-voltage power supply for proper operation. Other circuits, such as analog circuits and circuits that interface to external circuitry, require higher power supply voltages for operation. Moreover, these MCUs frequently operate on a battery voltage, and the MCUs generate internal voltages to power the different types of circuits. At the same time, it is necessary to conserve power and MCUs provide a variety of low-power modes to assist in power conservation. There is a tension between supporting different types of internal circuits and maintaining low-power operation because the power supply conversion circuits themselves consume a significant amount of the chip's power.

### BRIEF DESCRIPTION OF THE DRAWINGS

FIG. 1 illustrates in block diagram form an MCU known in the prior art;

FIG. 2 illustrates in block diagram form an MCU with a power-saving energy management circuit according to an embodiment;

FIG. 3 illustrates a state diagram of various power states supported by the MCU of FIG. 2;

FIG. 4 illustrates in partial block diagram and partial schematic form the power-saving power architecture of the MCU of FIG. 2; and

FIG. 5 illustrates a timing diagram illustrating the sequence of activating various circuits of the MCU of FIG. 4.

The use of the same reference symbols in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION

In one form, an integrated circuit includes a first plurality of circuits receiving a first internal power supply voltage, a first regulator, a second regulator, and a controller. The first regulator receives an external power supply voltage and supplies the first internal power supply voltage at a first rated power in response to the external power supply voltage when the integrated circuit is in an active mode. The second regulator receives the external power supply voltage and supplies the first internal power supply voltage at a second rated power less than the first rated power in response to the external power supply voltage when the integrated circuit is in a low power mode. The controller controls a transition of the integrated circuit between the active mode and the low power mode. The controller activates all of the first plurality of circuits in the active mode, and activates a subset of the first plurality of circuits while keeping remaining ones of the first plurality of circuits inactive in the low power mode.

In another form, a microcontroller includes a central processing unit (CPU) core coupled to a low-voltage power bus, a memory coupled to the low-voltage power bus and to the CPU core, a plurality of peripheral circuits coupled to a high-voltage power bus and to the CPU core; and a power saving energy management circuit. The power saving energy management circuit receives an external power supply voltage and provides a digital power supply voltage to the low-voltage power bus and a high-power supply voltage to the high-voltage power bus. The energy management circuit includes a first regulator, a second regulator, and a controller. The first regulator receives the external power supply voltage and supplies the digital power supply voltage to the low-voltage power bus at a first rated power in response to the external power supply voltage when the microcontroller is in an active mode. The second regulator receives the external power supply voltage and supplies the digital power supply voltage at a second rated power less than the first rated power in response to the external power supply voltage when the microcontroller is in a low power mode. The controller controls a transition of the microcontroller between the active mode and the low power mode. The controller activates the CPU core and the memory in the active mode, and places the CPU core and the memory into a low-power state in the low power mode.

In yet another form, a method of operating an integrated circuit, includes, in an active mode, generating a first internal power supply voltage having a first nominal voltage on a first power supply voltage rail using a first voltage regulator, and activating each of a first plurality of circuits coupled to the first power supply voltage rail. In a low power mode, the method includes generating the first internal power supply voltage having the first nominal voltage on the first power supply voltage rail using a second voltage regulator, wherein the second voltage regulator has a lower rated power than the first voltage regulator, and activating a subset of the first plurality of circuits while keeping remaining ones of the first plurality of circuits inactive.

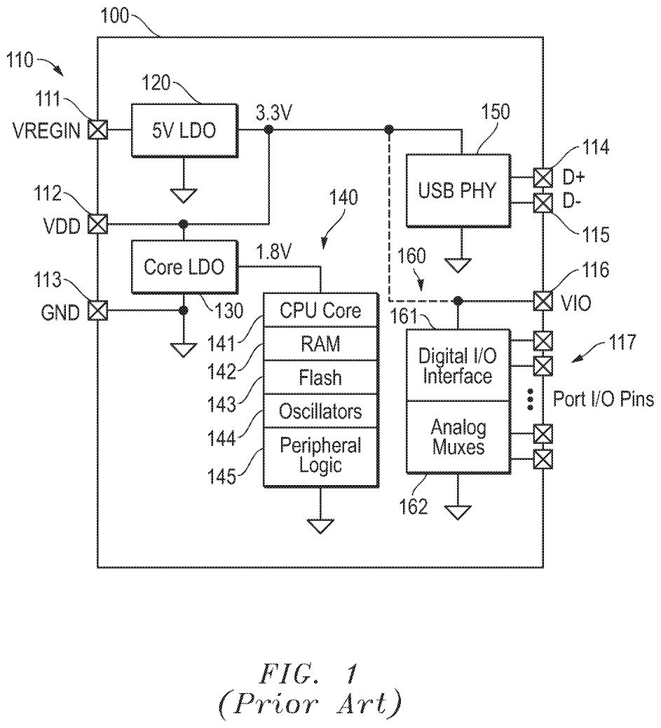

FIG. 1 illustrates in block diagram form an MCU 100 known in the prior art. MCU 100 includes a set of integrated circuit terminals 110, a low-dropout (LDO) voltage regulator 120, an LDO regulator 130, a set of digital circuit blocks 140, a universal serial bus (USB) physical layer interface circuit (PHY) 150, and a set of input/output circuits 160.

Integrated circuit terminals 110 include a terminal 111 for receiving an external regulated voltage labeled “VREGIN”, a terminal 112 for receiving a power supply voltage labelled “VDD”, a terminal 113 for receiving a ground voltage labelled “GND” to which VREGIN and VDD are referenced, a terminal 114 for conducting a positive USB data signal labeled “D+”, a terminal 115 for conducting a negative USB data signal labeled “D−”, a terminal 116 for receiving an input/output supply labeled “VIO”, and a set of terminals 117 functioning as digital and/or analog I/O port pins.

LDO voltage regulator 120 has an input connected to terminal 111, an output for providing a 3.3-volt internal power supply voltage, and a reference terminal connected to ground. VREGIN is an externally regulated power supply voltage having a nominal value of 5 volts. LDO voltage regulator 120 is adapted to convert VREGIN into an internal, regulated voltage having a value in this example of 3.3 volts.

LDO voltage regulator 130 has an input connected to terminal 112 and to the output of LDO voltage regulator 120, an output for providing a 1.8-volt internal power supply voltage, and a reference terminal connected to terminal 113, which provides the ground for MCU 100. In one mode, LDO voltage regulator is active and outputs the 3.3-volt internal power supply that LDO voltage regulator 130 uses to generate the 1.8-volt internal supply. In an alternate mode, LDO voltage regulator 120 is disabled and an external voltage regulator provides 3.3 volts to terminal 112.

Digital circuit blocks 140 includes an exemplary set of digital circuits useful in an MCU including a central processing unit core 141, a random access memory 142, a flash memory 143, an oscillators block 144, and a peripheral logic block 145. MCU 100 is implemented using low-power complementary metal-oxide-semiconductor (CMOS) transistors, and digital circuit blocks 140 operate on the relatively low power supply voltage of 1.8 volts.

USB PHY 150 has bidirectional terminals connected to terminals 114 and 115 is powered from the internal 3.3-volt power supply. Input/output circuits 160 include a set of digital I/O circuits 161 and a set of analog multiplexers 162. Each of these circuit groups is connected to corresponding ones of terminals 117 and both of them are powered by the 3.3 internal power supply voltage in one more, and terminal 116 in the other mode.

MCU 100 uses LDO voltage regulator 120 and LDO regulator 130 to provide the internal 3.3-volt and 1.8-volt power supply voltages, respectively. In general, LDOs are simple to implement using, e.g., a single high-power series transistor with a simple feedback loop using a comparator and a voltage reference to control the conductivity of the pass transistor to regulate the output to the desired voltage. While simple in construction, however, LDO regulators are relatively inefficient at lighter loads.

In order to generate stable internal power supplies, conventional MCUs require large load capacitors for each on-chip power supply. However, these large load capacitors cause problems. First, they cause the MCU to have high current consumption, because a voltage regulator having large load capacitor must generate a large bias current to make itself stable. Second, if they are integrated on-chip, they increase the circuit area and chip cost. If the MCU cannot support a large current, then the regulator must increase the capacitance of the load capacitor further so that it becomes the dominant pole for stability, requiring a still larger capacitor and resulting in a further increase of the die area and the cost of the chip. Third, if it is not possible to integrate load capacitors with adequate sizes on-chip, then the chip would require large external capacitors and integrated circuit terminals to connect to the off-chip capacitors, which increases chip die area and cost. Thus, the use of large load capacitors makes it difficult to provide a low-cost, low-power MCU.

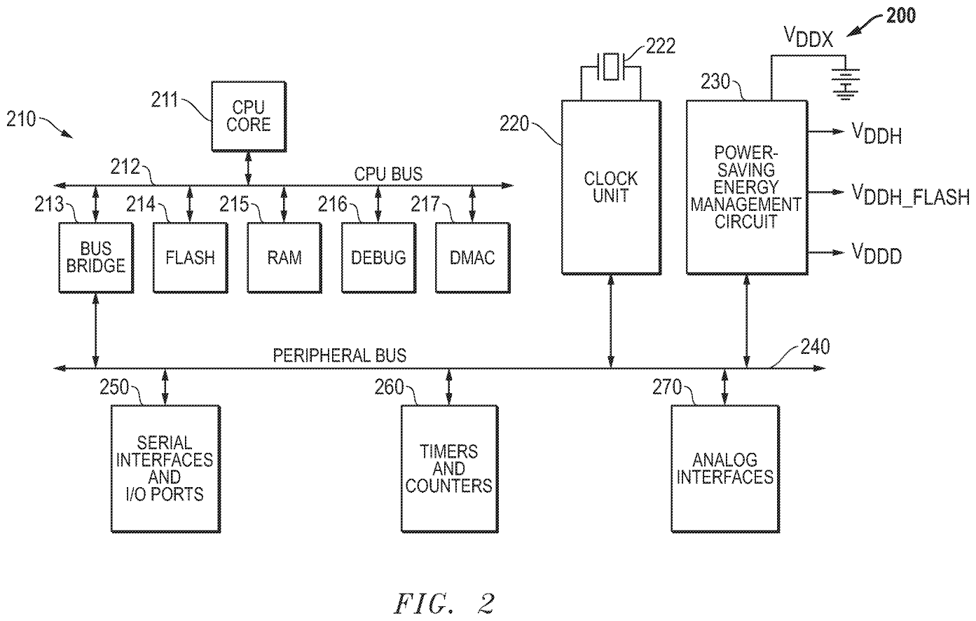

FIG. 2 illustrates in block diagram form an MCU 200 with a power-saving energy management circuit according to an embodiment. MCU 200 is an integrated circuit MCU that includes generally a CPU system 210, a clock unit 220, a power-saving energy management circuit 230, a peripheral bus 240, a set of serial interfaces and I/O ports 250, a set of timers and counters 260, and a set of analog interfaces 270.

CPU system 210 includes a CPU bus 212 interconnecting a CPU core 211, a bus bridge 213, a FLASH memory 214, a random-access memory (RAM) 215, a debug circuit 216, and a direct memory access controller (DMAC) 217. CPU system 210 includes a CPU bus 212 separate from peripheral bus 240 to isolate transactions initiated by CPU core 211 to local devices and memory without affecting traffic on peripheral bus 240. Bus bridge 213 is a circuit that allows cross-bus transfers between CPU bus 212 and peripheral bus 240. CPU system 210 provides FLASH memory 214 for non-volatile storage of program code that can be bootstrap loaded from an external source, as well as parameters that need to be preserved when MCU 200 is powered down. RAM 215 provides a working memory for use by CPU core 211. Debug circuit 216 provides program trace capabilities with access to registers on CPU core 211 for software debug. DMAC 217 provides programmable direct memory access channels to offload CPU core 211 from routine data movement tasks between peripherals and memory.

MCU 200 includes a set of peripherals that make it suitable for a variety of general-purpose embedded applications. Peripheral bus 240 interconnects bus bridge 213, clock unit 220, power-saving energy management circuit 230, serial interfaces and I/O ports 250, timers and counters 260, and analog interfaces 270. The serial interfaces in serial interfaces and I/O ports 250 operate according to a variety of synchronous and asynchronous character-oriented and serial protocols. The I/O ports in serial interfaces and I/O ports 250 are a set of general-purpose input/output circuits with terminals that can be programmed for specific functions or remain available to software for general purpose operation. Timers and counters 260 provide various programmable timing and event counting functions useful for embedded control, and include a watchdog timer and a real time clock. Analog interfaces 270 include various analog interface circuits such as an analog comparator and an analog-to-digital converter (ADC) for accurate analog input signal measurement.

Generally, MCU 200 integrates CPU system 210 and several peripherals for a wide variety of application environments and is suitable for very low power operation. MCU 200 includes a clock unit 220 that provides a variety of clocks and clock functions that MCU 200 uses to support its low power modes. For example, clock unit 220 can include high frequency oscillators, as well as lower precision fully integrated resistor-capacitor (RC) oscillators and very low speed RC oscillators that allow standby and keep-alive operations.

MCU 200 also includes power-saving energy management circuit 230 that implements a power architecture that provides several programmable functions to support extremely low-power operation in low-power modes. Power-saving energy management circuit 230 is bidirectionally connected to peripheral bus 240 and has an input for receiving an external power supply voltage labeled “V_{DDX}”, outputs for providing a relatively high-power supply voltage labeled “V_{DDH}”, a relatively high-power supply voltage for FLASH memory 214 labeled “V_{DDH_FLASH}”, and a relatively low digital power supply voltage labeled “V_{DDD}”. In this exemplary embodiment, these voltages have the nominal values shown in TABLE I:

TABLE I

| Name | Description | Nominal Voltage |
|---|---|---|
| V_{DDX} | External power supply voltage | 5 V |
| V_{DDH}_FLASH | Internal high voltage for FLASH | 3 V |
| | memory | |
| V_{DDH} | Internal high voltage for analog | 2.4 V |
| | interfaces and I/O circuits | |
| V_{DDD} | Internal supply voltage for digital | 1.2 V |
| | CMOS and oscillators | |

V_{DDX} is an input voltage for all on-chip voltage regulators, as well as I/O signals. V_{DDH} is a voltage used to power analog circuits and circuits that implement external I/O functions. V_{DDH_FLASH} is a voltage provided to FLASH memory 214 to allow it to generate further voltages to program and erase floating-gate memory cells. V_{DDD} is a relatively low voltage provided to digital CMOS circuits such as CPU core 211.

Power-saving energy management circuit 230 also provides other functions besides voltage generation. For example, it also includes a brown-out detector designed to force MCU 200 into reset when power consumption is too high, as well as a low-power power on reset circuit. It implements a state machine to control entry into and exit from various low-power modes. In particular, power-saving energy management circuit 230 provides an internal architecture with multiple voltage regulators for the supported power supply voltages but that operate efficiently in different load ranges created by the different power-saving modes. Further details of the power-saving architecture will now be described.

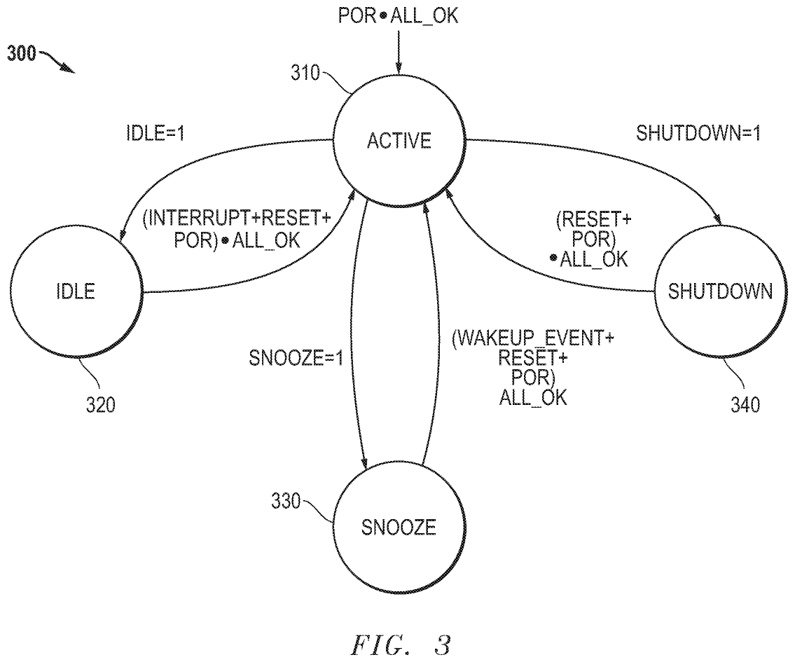

FIG. 3 illustrates a state diagram 300 of various power states supported by MCU 200 of FIG. 2. State diagram 300 includes four power states or modes, including an active mode 310, an idle mode 320, a snooze mode 330, and a shutdown mode 340. When power is applied to MCU 200 at initial power-on, MCU 200 enters active mode 310 when a power-on reset signal labeled “POR” is active to indicate that the power supply voltage has ramped to a suitable voltage for operation, and a signal labeled “ALL_OK” is active to indicate that all internal voltage regulators are active and have reached their nominal levels. Active mode 310 is the normal operation state in which all circuits are powered up and enabled, and CPU core 211 begins operation by fetching and executing instructions. The available low-power states, i.e. idle mode 320, snooze mode 330, and shutdown mode 340, are entered only from active mode 310.

MCU 200 enters idle mode 320 when a control signal labeled “IDLE” is activated, e.g. by software setting a corresponding IDLE bit in a memory-mapped power control register. In other embodiments, the IDLE signal can be set in different ways, such as from an activity detector failing to detect any activity for a certain period of time, in response to an external control signal, and the like. In idle mode 320, the clocks are removed from the CPU and from certain peripherals, but power continues to be applied to all circuits. Because MCU 200 is implemented with CMOS circuits, they do not lose their state when clock signals are removed. All power supplies remain fully powered, allowing a relatively fast wakeup time, but MCU 200 still consumes leakage power, power consumed by selected peripherals remain active to report wakeup events, and power consumed by the voltage regulators. MCU 200 can return to active mode 310 in response to the activation of either an enabled interrupt or an activation of a reset terminal (i.e. a warm reset), if the ALL_OK signal is true.

MCU 200 enters snooze mode 330 when a control signal labeled “SNOOZE” is activated, e.g. by software setting a corresponding SNOOZE bit in the memory-mapped power control register. In other embodiments, the SNOOZE signal can be set in different ways, such as from an activity detector failing to detect any activity for a certain period of time, in response to an external control signal, and the like. In snooze mode 330, the clocks are removed from the CPU, from certain peripherals, and from high-power voltage regulators, but as will be explained below, low-power voltage regulators continue to apply power to all voltage domains so the components do not lose their state. MCU 200 can return to active mode 310 in response to a wakeup event (an enabled interrupt, a signal from a watchdog timer, etc.), activation of the reset terminal (i.e. a warm reset), or a hard reset (cycling the external power pins), if the ALL_OK signal is true.

MCU 200 enters shutdown mode 340 when a control signal labeled “SHUTDOWN” is activated, e.g. by software setting a corresponding SHUTDOWN bit in the memory-mapped power control register. In other embodiments, the SHUTDOWN signal can be set in different ways, such as from an activity detector failing to detect any activity for a certain period of time, in response to an external control signal, and the like. In shutdown mode 340, external I/O pins, powered by external power supply voltage V_{DDX}, retain their states, but the clocks and internal power are removed from all circuits, including all voltage regulators. MCU 200 can return to active mode 310 only in response to a reset, indicated by either an activation of the reset terminal (i.e. a warm reset) or a hard reset (cycling the external power pins), if the ALL_OK signal is true.

TABLE II summarizes the various power modes supported by MCU 200:

TABLE II

| State | Internal Circuits | Voltage Regulators |
|---|---|---|
| ACTIVE | All internal circuits are active | All voltage regulators are |
| | | enabled |
| IDLE | CPU core 211 halts and its clocks are gated | All voltage regulators are |
| | off; FLASH memory 214 activity stops; | enabled |
| | remaining circuits are active; all internal | |
| | circuits are powered; power consumption is | |
| | reduced from active mode; wakeup latency is | |
| | low | |
| SNOOZE | LF oscillator 437 and FS oscillator 438, | High-power voltage |
| | watchdog timer 435, and analog comparator | regulators are disabled, but |
| | are ON. CPU core 211 halts and its clocks | low-power voltage regulators |
| | are gated off; FLASH memory 214 activity | are enabled |
| | stops; remaining circuits are inactive; power | |
| | consumption is reduced from idle mode; | |
| | wakeup latency is medium | |
| SHUTDOWN | I/O buffers 432 keep their same states before | All voltage regulators are |
| | going into SHUTDOWN mode; all | disabled |
| | remaining circuits are off; power | |
| | consumption is reduced from snooze mode; | |
| | wakeup latency is high | |

While certain low power modes and their corresponding behavior was described, in other embodiments, MCU 200 may support additional low power modes besides those shown in FIG. 3 and TABLE II. For example, different combinations of peripherals can remain active or can be disabled in these additional low-power modes. Moreover, the behavior of these peripherals in these various low power modes, as well as the specific interrupts or wakeup events allowed to bring MCU 200 out of the IDLE and/or SNOOZE modes, can be software programmable.

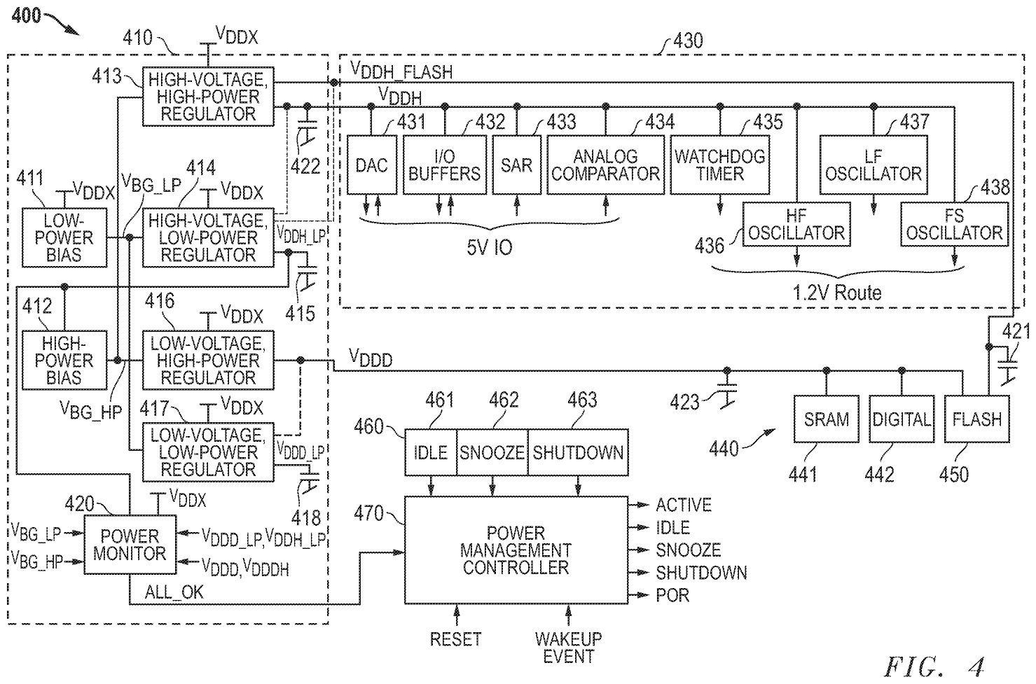

FIG. 4 illustrates in partial block diagram and partial schematic form an MCU 400 illustrating the power-saving power architecture of MCU 200 of FIG. 2. MCU 400 includes generally a set of voltage regulators 410, a set of high-voltage peripherals 430, a set of digital circuits 440, a FLASH memory 450, a control register 460, and a power management controller 470.

Voltage regulators 410 are part of power-saving energy management circuit 230 and include a low-power bias circuits 411, a high-power bias circuit 412, regulators 413 and 414, a capacitor 415, regulators 416 and 417, a capacitor 418, a power monitor 420, and capacitors 421, 422, and 423. Low-power bias circuit 411 is a low-power bias circuit having a power supply terminal for receiving V_{DDX}, and an output for providing a bias signal labeled “V_{BG_LP}”. High-power bias circuit 412 is a high-power bias circuit having a power supply terminal, and an output for providing a bias signal labeled “V_{BG_HP}”. Regulator 413 is a high-voltage, high-power regulator having a power supply terminal for receiving V_{DDX}, a reference input for receiving V_{BG_HP}, a first output for providing V_{DDH} through a replica path, a second output for providing V_{DDH_FLASH} through a replica path, and a third output connected to input of high-power bias circuit 412 for providing a voltage labeled “V_{DDH_LP}”. Regulator 414 is a high-voltage, low-power regulator having a power supply terminal for receiving V_{DDX}, a reference input for receiving V_{BG_LP}, a first output connected to the second output of regulator 413, and a second output connected to the power supply input of high-power bias circuit 412. Capacitor 415 has a first terminal connected to the second output of regulator 414, and a second terminal connected to ground. Regulator 416 is a low-voltage, high-power regulator having a power supply terminal for receiving V_{DDX}, a reference input for receiving V_{BG_HP}, and an output for providing V_{DDD}. Regulator 417 is a low-voltage, low-power regulator having a power supply terminal for receiving V_{DDX}, a reference input for receiving V_{BG_LP}, a first output connected to the output of regulator 416, and a second output. Capacitor 418 has a first terminal connected to the second output of regulator 417, and a second terminal connected to ground. Power monitor 420 has a power supply input for receiving V_{DDX}, a first input for receiving V_{DDH_LP}, a second input for receiving V_{BG_LP}, a third input for receiving V_{BG_HP}, a fourth input for receiving V_{DDD_LP}, a fifth input for receiving V_{DDH_LP}, a sixth input for receiving V_{DDD}, a seventh input for receiving V_{DDH}, and an output for providing a control signal labelled “ALL_OK”. Capacitor 421 has a first terminal for receiving V_{DDH_FLASH}, and a second terminal connected to ground. Capacitor 422 has a first terminal for receiving V_{DDH}, and a second terminal connected to ground. Capacitor 423 has a first terminal for receiving V_{DDD}, and a second terminal connected to ground.

High-voltage peripherals 430 include a digital-to-analog converter 431, a set of I/O buffers 432, a successive approximation register (SAR) 433, and an analog comparator 434 all connected to high-voltage (e.g. 5 volt) I/O, a watchdog timer 435, a high frequency oscillator 436, a low frequency oscillator 437, and a fast startup (FS) oscillator 438 that communicate to internal digital peripherals on a 1.2-volt supply voltage. Each of high-voltage peripherals 430 has a power supply terminal for receiving V_{DDH}, and a ground terminal connected to ground.

Digital circuits 440 includes an SRAM 441 and a digital block 442. Digital block 442 represents the digital circuits other than SRAM 441, such as CPU core 211, bus bridge 213, debug circuit 216, DMAC 217 of MCU 200 of FIG. 2. Each circuit or set of circuits in digital block 440 has a power supply terminal for receiving V_{DDH}, and a ground terminal connected to ground.

FLASH memory 450 has a first power supply voltage terminal for receiving V_{DDH_FLASH}, a second power supply voltage terminal for receiving V_{DDD}, and a ground terminal connected to ground. FLASH memory 450 performs read, write, and erase cycles internally using V_{HHD_FLASH} (or a voltage derived from V_{DDH_FLASH}, but communicates with CPU core 211 over CPU bus 212 with signals referenced to V_{DDD}, and thus uses both power supply voltages.

Control register 460 has three bits (or bit fields) to indicate a request to enter a low-power mode, including a SNOOZE bit 461, an IDLE bit 462, and a SHUTDOWN bit 463.

Power management controller 470 has a first input for receiving a signal labeled “RESET”, a second input for receiving a wakeup event signal labeled “WAKEUP_EVENT”, a third input for receiving the ALL_OK signal, inputs connected to the outputs of control register 460, and outputs for providing signals indicating, directly or indirectly, that integrated circuit 400 if in the active mode, the snooze mode, the idle mode, and the shutdown mode, and an output labeled “POR” (power-on reset).

In operation, power management controller 470 determines the operating mode of MCU 400, in which the operating mode can be requested by software setting the bit or bit field corresponding to the desired mode in control register 460. Power management controller 470 then enters the appropriate mode when all pre-conditions have been met, such as power monitor 420 indicating that all power supply voltages have been enabled through the ALL_OK signal. Power management controller 470 also observes the POR, RESET, and WAKEUP_EVENT signals to determine when to make power state transitions. The supported power modes were previously shown in TABLE II above.

MCU 400 has a power architecture that simultaneously achieves low cost and low power consumption. In order to achieve both goals at the same time, MCU 400 does not use the known, large capacitor approach described above, but approaches the two goals separately.

MCU 400 achieves low cost by partitioning its constituent circuits according to function, noise, voltage, and current requirements. FLASH memory 450 generates a high level of noise and uses high voltage and current. Thus, FLASH memory 450 receives a stronger supply, i.e. a supply with higher rated power, and uses a relatively large on-chip capacitor, namely capacitor 421 with a value of 150 picoFarads (pF). Analog circuitry including DAC 431, SAR 433, and analog comparator 434 generate less noise and use a relatively small current, but require a power supply that produces a stable, low-noise voltage. Thus, the analog circuitry receives a lower supply voltage V_{DDH} with a smaller rated power consumption and a smaller on-chip capacitor, namely capacitor 422 with a value of 75 pF. High-power bias circuit 412 and power monitor 420 generate very little noise and use a very low current, but require a power supply that produces a stable, low-noise voltage to provide stable reference voltages and accurate ALL_OK signals. Thus, high-power bias circuit 412 and power monitor 420 receive a lower power supply voltage VDDH_LP and a very small on-chip capacitor 415, namely capacitor 415 with a value of 10 pF. SRAM 441 and digital block 442 generate a high amount of noise and use large amounts of current but since they are digital CMOS circuits, they can operate with relatively low voltages. Thus, SRAM 441 and digital block 442 receive the lowest power supply voltage V_{DDD} but use the largest capacitor, namely on-chip capacitor 423 with a value of 700 pF.

Partitioning MCU 400 into these functional groups allows the total on-chip capacitance value to be reduced for a given die area and current/power consumption by using large capacitors only used for voltage domains with the greatest need. In addition, partitioning MCU 400 into these functional groups isolates noise generated in one partition (or voltage domain) from the other partitions.

MCU 400 achieves low power by providing one set of high-power regulators and bias reference circuits, and another set (or “replica” set) of low-power regulators and bias reference circuits. The high-power regulators include regulators 413 and 416, and the high-power reference circuit is high-power bias circuit 412. These circuits provide fast-settling, highly-accurate internal supply and reference voltages. Regulators 413 and 416 support relatively large current loadings, for example up to 12 milliamps (mA) for V_{DDH_FLASH}, 6 mA for V_{DDH}, and 10 mA for V_{DDD}. The low-power regulators include regulators 414 and 417, and the low-power bias circuit includes low-power bias circuit 411. Regulators 414 and 417 support internal power supplies that have a moderate level of accuracy and settling time, but consume far lower amounts of bias current compared to their higher rated power counterparts. Regulators 414 and 417 support smaller current loadings of up to 20 μA for V_{DDH_FLASH}, 100 μA for V_{DDH}, and 1 mA for V_{DDD}, but only require a bias current of approximately 6.5 μA.

Different combinations of high-power and low-power regulators and bias reference circuits can be used to support different power modes. Each power supply voltage rail uses both a main branch and a replica branch to alternate between regulators that have higher rated powers and those that have lower rated powers. FIG. 4 shows the replica branches as dashed lines. The regulators that supply the replica branches are open-loop circuits which are unconditionally stable for any load capacitor and allow transitions between the regulators corresponding to different power modes. The main branches and their corresponding replica branches for the different power supply voltage rails are shown in TABLE III:

TABLE III

| Power | Main | Main | Replica | Replica |
|---|---|---|---|---|
| Supply Rail | Supply | Voltage | Supply | Voltage |
| V_{DDH}_FLASH | Regulator 413 | 3 V | Regulator 414 | 2.1 V |
| V_{DDH} | Regulator 413 | 2.4 V | Regulator 414 | 2.1 V |
| V_{DDD} | Regulator 416 | 1.2 V | Regulator 417 | 1.2 V |

Consistent with the selected power state, voltage regulators 410 provide various power supply voltages to internal circuits of MCU 400 using alternate voltage regulators as specifically outlined in TABLE IV:

TABLE IV

| | ACTIVE | | SNOOZE | SHUTDOWN |
|---|---|---|---|---|
| SUPPLY | MODE | IDLE MODE | MODE | MODE |
| V_{DD}_FLASH | 413 (main) | 414 (replica) | 414 (replica) | ALL OFF |
| V_{DDH} | 413 (main) | 413 (main) | 414 (replica) | ALL OFF |
| V_{DDH}_LP | 414 (main) | 414 (main) | 414 (main) | ALL OFF |
| V_{DDD} | 416 (main) | 416 (main) | 417 (replica) | ALL OFF |

In addition, the states of the voltage regulators of MCU 400 when it is in various power modes are shown in TABLE V below:

TABLE V

| CIRCUITS IN | | | | |
|---|---|---|---|---|
| REGULATORS | ACTIVE | IDLE | SNOOZE | SHUTDOWN |
| 410 | MODE | MODE | MODE | MODE |
| 411 | ON | ON | ON | OFF |
| (V_{BG}_LP) | | | | |
| 412 | ON | ON | OFF | OFF |
| (V_{BG}_HP) | | | | |
| 413 | ON | ON | OFF | OFF |
| (V_{DDH}) | | | | |
| 413 | ON | OFF | OFF | OFF |
| (V_{DDH}_FLASH) | | | | |
| 414 (main) | ON | ON | ON | OFF |
| (V_{DDH}_LP) | | | | |
| 414 (replica) | OFF | OFF | ON | OFF |
| (V_{DDH}) | | | | |
| 414 (replica) | OFF | ON | ON | OFF |
| (V_{DDH}_FLASH) | | | | |
| 416 | ON | ON | OFF | OFF |
| (V_{DDD}) | | | | |
| 417 (main) | ON | ON | ON | OFF |
| (V_{DDD}_LP) | | | | |
| 417 (replica) | OFF | OFF | ON | OFF |
| (V_{DDD}) | | | | |
| TOTAL BIAS | 600 μA | 250 μA | 6.5 μA | 0.3 μA |
| CURRENT | | | | |

In one specific example, the total bias current for all the voltage regulators is 600 microamps (μA) in active mode, 200 μA in idle mode, 6.5 μA in snooze mode, and 0.3 μA in shutdown mode. When MCU 400 transitions from active mode to idle mode, power management controller 470 turns off regulator 413, and power consumption reduces to 200 μA. When MCU 400 transitions from active mode to snooze mode, power management controller 470 turns off high-power bias circuit 412, high-power regulator 413, and high-power regulator 416, and power consumption reduces to 6.5 μA. When MCU 400 transitions from active mode to shutdown mode, power management controller 470 turns off all regulators and bias circuits, and power consumption reduces to 0.3 μA.

Digital circuits 440 operate in the V_{DDD} domain and receive V_{DDD} as their power supply voltage. Portions of SRAM 441 and digital block 442 remain powered during snooze mode, while power is gated off to other portions. For example, regulator 417 continues to provide power supply voltage V_{DDD} to the memory core so that it retains its state while MCU 400 is in the snooze mode, but SRAM 441 power gates the access circuitry. Thus SRAM 441 only consumes leakage power in its core, but no power in the power-gated circuits. Likewise, portions of digital circuits 440 are power gated, while other portions are powered by the low-voltage supply.

FLASH memory 450 stops receiving V_{DDH_FLASH} from voltage regulator 413 when in idle mode 320, snooze mode 330, and shutdown mode 340, but continues to receive VDDH_FLASH from voltage regulator 414 using the replica path in the idle and snooze modes so it. However, in these modes, MCU 400 does not allow read, write, and erase accesses to FLASH memory 450 since any circuits that may access them, including CPU core 211, are disabled. Since it is non-volatile, FLASH memory 450 retains its contents when powered down. FLASH memory 450 continues to receive V_{DDD} using regulator 417 in the idle and snooze modes.

By using separate voltage regulators that are tailored for lower rated power in idle and/or snooze modes, MCU 400 saves significant amounts of bias current that would be required by the higher power rated voltage regulators used in active mode. Thus MCU 400 provides low power consumption in low power modes, saving battery life, while preserving compact integrated circuit size and hence preserving low cost. Also, by separating voltage regulators based on the types of circuits powered by them, MCU eliminates the need for an external capacitor that is large enough for most or all of the internal circuitry, and thus saves the cost of an external capacitor and extra MCU terminal. The design of the regulators can also be changed according to their need. For example in one embodiment, regulator 413 can be implemented as an LDO regulator to provide better efficiency at large loads, while regulator 414 can be implemented as a regulated charge pump, which provides better efficiency at lighter loads.

Power monitor 420 determines whether all power supply circuits are operational such that MCU 400 can enter active mode 310. Power monitor 420 has inputs for receiving both the low-power bias voltage V_{BG_LP} and the high-power bias voltage V_{BG_HP}, as well as each of the supply voltages V_{DDX}, V_{DDH_LP}, V_{DDD_LP}, V_{DDH}, and V_{DDD}.

Power management controller 470 causes the various regulators to power up in an orderly fashion as follows. Low-power bias circuit 411 receives external power supply voltage V_{DDX}, and provides bias voltage V_{BG_LP} as soon as V_{DDX} rises to a sufficient voltage. V_{BG_LP} is a reference voltage that is equal to or is based on a bandgap voltage. The bandgap of silicon is 1.2 volts, so if V_{BG_LP} is equal to the bandgap voltage, V_{DDX} must rise to a sufficient voltage above 1.2 volts so that the bandgap voltage generation circuit is operational. Once V_{BG_LP} is at its proper level, regulators 414 and 417 can provide their respective output voltages at proper levels. The second output of high-voltage, low-power regulator generates V_{DDH_LP}, which is provided on a separate signal line to high-power bias circuit 412. Once regulator 414 becomes operational and provides V_{DDH_LP} at its proper level, high-power bias circuit 412 can become operational. Moreover, once high-power bias circuit 412 becomes operational, it biases regulators 413 and 416 and they begin ramping their respective output voltages by charging up capacitors 422 and 423, respectively. Once these voltages reach their nominal levels, then power monitor 420 activates signal ALL_OK, and power management controller 470 transitions MCU 400 into the Active mode, and asserts the ACTIVE signal.

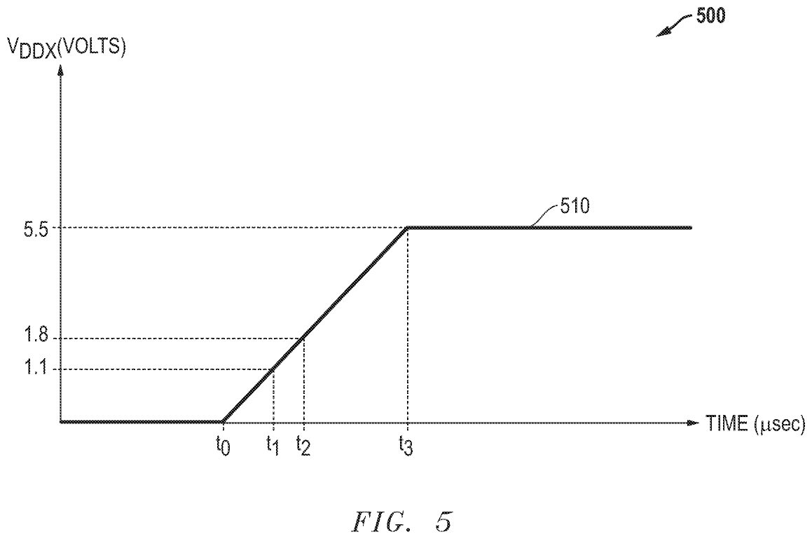

FIG. 5 illustrates a timing diagram 500 illustrating the sequence of activating various circuits of MCU 400 of FIG. 4. In timing diagram 500, the horizontal axis represents time in uses, and the vertical axis represents the value of external power supply voltage V_{DDX} in volts. Timing diagram 500 shows a waveform 510 representing the value of external power supply voltage V_{DDX} as it ramps from zero voltage to a value of 5.5 volts at the high end of its allowed range. Timing diagram 500 also shows four time points of interest, labeled “t₀”, “t₁”, “t₂”, and “t₃”.

The sequence of powering up MCU 400 can be summarized as follows. Power supply voltage V_{DDX} starts in an off state at 0 volts and ramps up until time to when it reaches a voltage of 0.6 volts. Before time t₁, all circuits in regulators 410 are disabled.

At time t₁, V_{DDX} reaches 0.6 volts. The value of 0.6 volts corresponds to a threshold voltage of a 3-volt N-channel MOS transistor. At time t₁, low power bias circuit 411 is turned on, and after a delay, power monitor 420 starts monitoring power supply voltages, and regulators 414 and 417 are also turned on without activating the replica branches. When the output of low-power bias circuit 411 exceeds a threshold voltage of a 3-volt P-channel MOS transistor plus a drain-to-source voltage of a 3-volt N-channel MOS transistor, power monitor 420 enables a charge pump function of regulators 414 and 417 to allow them to generate voltages greater than V_{DDX} using their replica branches. When power monitor 420 detects that V_{DDH_LP}>1.5 volts and V_{DDD_LP}>0.9V, then power monitor 420 enables high-power bias circuit 412. When power monitor 420 detects that the output of high-power bias circuit 412 is greater than 1 volt, it turns on voltage regulator 413 and low-voltage, high power regulator 416. Finally, when power monitor 420 detects V_{DDH}>1.57 volts and V_{DDD}>1 volt, then power monitor 420 starts to detect the V_{DDX} level.

At time t₂, power monitor 420 detects that V_{DDX} has reached 1.8 volts. power monitor 420 activates ALL_OK, and power management controller 470 places MCU 400 into the active mode, in which all circuitry is operational. Power monitor 420 programs the voltage regulators to more accurate, calibrated settings stored by MCU 400, allowing voltage regulators 410 to provide highly accurate internal voltages. It then reduces the V_{DDX} threshold to 1.71 volts, which is the level at which the chips will enter shutdown mode, and providing an increased V_{DDX} operating range. Power monitor 420 allows read operations to FLASH memory 214 until it detects that V_{DDH_FLASH}≥2.4V, at which time it enables FLASH memory 214 for write and erase operations as well as read operations.

MCU 400 changes from active mode 310 to snooze mode 330 as follows. When SNOOZE=1, a snooze controller inside power management controller 470 activates low-power regulators 414 and 417 and replica paths for V_{DDH}, V_{DDH_FLASH}, and V_{DDD}, and during this time both high-power regulators 413 and 416 and low-power regulators 414 and 417 are active. The snooze controller controls regulator 417 to reduce V_{DDD} to 1.1 volts to remove any transient glitch when regulator 416 is disabled. After a certain period of time, the snooze controller disables high-power regulator 413 and high-power regulator 416 and high-power bias circuit 412. The current consumption of voltage regulators 410 is reduced from 600 μA to about 6.5 μA, with less accurate output voltages, and MCU 400 is then in snooze mode.

MCU 400 changes from snooze mode 330 back to active mode 310 as follows. When ACTIVE=1, regulators 413 and 414 are reactivated. Power management controller 470 controls regulator 417 to increase V_{DDD} to 1.2 volts, and activates high-power bias circuit 412, and regulators 413 and 415. After another certain period of time, both regulators 414 and 417 and the replica paths are disabled. The current consumption of voltage regulators 410 is increased from 6.5 μA to about 600 μA, and the outputs of regulators 413 and 416 are again highly accurate. MCU 400 is then in active mode.

According to one aspect of the disclosed embodiments, MCU 400 includes a set of circuits that define a voltage domain, e.g. high-voltage peripherals 430 in the V_{DDH} voltage domain that receive V_{DDH} as their power supply voltage. To generate V_{DDH}, power-saving energy management circuit 230 uses either voltage regulator 413 or voltage regulator 414. For example, when MCU 400 is in the active mode, power management controller 470 uses the V_{DDH} generated by high-power, high voltage regulator 413, since it is efficient at high power levels and has a higher rated power than regulator 414. However, when MCU 400 is in the snooze mode, certain ones of high-voltage peripherals 430 are disabled, and power-saving energy management circuit 230 uses high-voltage, low-power regulator 414 to generate V_{DDH}. In the Snooze mode, power management controller 470 disables regulator 413. Regulator 414 has a lower rated power than regulator 413, and while it is unable to generate V_{DDH} at a stable voltage at high power levels, it is more efficient than regulator 413 in generating power supply voltage V_{DDH} at relatively low power levels.

Likewise, to generate V_{DDD}, power-saving energy management circuit 230 uses either voltage regulator 416 or voltage regulator 417. For example, when MCU 400 is in the active mode, power management controller 470 uses the V_{DDD} generated by high-power, low-voltage regulator 416, since it is efficient at high power levels and has a higher rated power than regulator 417. However, when MCU 400 is in the snooze mode, certain ones of digital circuits 440 are disabled, and power-saving energy management circuit 230 uses low-voltage, low-power regulator 417 to generate V_{DDD}. In the Snooze mode, power management controller 470 disables regulator 416. Regulator 417 has a lower rated power than regulator 416, and while it is unable to generate V_{DDD} at a stable voltage at high power levels, it is more efficient than regulator 416 in generating power supply voltage V_{DDD} at relatively low power levels.

The above-disclosed subject matter is to be considered illustrative, and not restrictive, and the appended claims are intended to cover all such modifications, enhancements, and other embodiments that fall within the true scope of the claims. For example, various low-power modes have been described, but in other embodiments the MCU may support other low-power modes that keep a different set of internal circuits active while powering down other circuits. The conditions in which the various modes are entered and exited may also change in difference embodiments. Also while the current consumption was described with respect to a particular example, the values are only approximate, and different integrated circuits and MCUs will have difference current levels.

Thus, to the maximum extent allowed by law, the scope of the present invention is to be determined by the broadest permissible interpretation of the following claims and their equivalents, and shall not be restricted or limited by the foregoing detailed description.

1. An integrated circuit, comprising:
a first plurality of circuits receiving a first internal power supply voltage;
a first regulator receiving an external power supply voltage and supplying said first internal power supply voltage at a first rated power in response to said external power supply voltage when the integrated circuit is in an active mode;
a second regulator receiving said external power supply voltage for supplying said first internal power supply voltage at a second rated power less than said first rated power in response to said external power supply voltage when the integrated circuit is in a low power mode; and
a controller for controlling a transition of the integrated circuit between said active mode and said low power mode, wherein said controller activates all of said first plurality of circuits in said active mode, and activates a subset of said first plurality of circuits while keeping remaining ones of said first plurality of circuits inactive in said low power mode.

2. The integrated circuit of claim 1, wherein:
said first regulator comprises a low drop-out regulator; and
said second regulator comprises a regulated charge pump that supplies said first internal power supply voltage using a corresponding replica branch.

3. The integrated circuit of claim 1, comprising:
a second plurality of circuits receiving a second internal power supply voltage, wherein said second internal power supply voltage is lower than said first internal power supply voltage;
a third regulator receiving said external power supply voltage and supplying said second internal power supply voltage at a third rated power in said active mode in response thereto; and
a fourth regulator receiving said external power supply voltage and supplying said second internal power supply voltage at a fourth rated power less than said third rated power in said low power mode.

4. The integrated circuit of claim 3, wherein:
said third regulator comprises a low drop-out regulator; and
said fourth regulator comprises a regulated charge pump that supplies said second internal power supply voltage using a corresponding replica branch.

5. The integrated circuit of claim 3, wherein:
said controller activates each of said second plurality of circuits in said active mode by providing a respective clock signal thereto, and keeps said remaining ones of said first plurality of circuits inactive in said low power mode by halting a respective clock signal thereto.

6. The integrated circuit of claim 3, wherein the integrated circuit is a microcontroller, and wherein:
said first plurality of circuits comprises an analog interface circuit; and
said second plurality of circuits comprises a central processing unit (CPU) core, a memory, and a bus bridge having a first port coupled to said CPU core, and a second port coupled to said memory.

7. The integrated circuit of claim 1, wherein:
in response to detecting an idle event, said controller further controls a transition of the integrated circuit between said active mode and an idle mode, wherein in said idle mode, said controller places a central processing unit (CPU) core in a sleep mode, and continues to power all of said first plurality of circuits using said first regulator.

8. A microcontroller, comprising:
a central processing unit (CPU) core coupled to a low-voltage power bus;
a memory coupled to said low-voltage power bus and to said CPU core;
a plurality of peripheral circuits coupled to a high-voltage power bus and to said CPU core; and
an energy management circuit for receiving an external power supply voltage and providing a digital power supply voltage to said low-voltage power bus and a high-power supply voltage to said high-voltage power bus, wherein said energy management circuit comprises:
a first regulator receiving said external power supply voltage and supplying said digital power supply voltage to said low-voltage power bus at a first rated power in response to said external power supply voltage when the microcontroller is in an active mode;
a second regulator receiving said external power supply voltage and supplying said digital power supply voltage at a second rated power less than said first rated power in response to said external power supply voltage when the microcontroller is in a low power mode; and
a controller for controlling a transition of the microcontroller between said active mode and said low power mode, wherein said controller activates said CPU core and said memory in said active mode, and places said CPU core and said memory into a low-power state in said low power mode.

9. The microcontroller of claim 8, wherein said controller places said CPU core and said memory into said low power mode by disabling clocking to said CPU core and said memory while continuing to supply said digital power supply voltage to said CPU core and said memory using said second regulator.

10. The microcontroller of claim 8, wherein said energy management circuit further comprises:
a third regulator receiving said external power supply voltage and supplying a high-power supply voltage to said high-voltage power bus at a third rated power in response to said external power supply voltage when the microcontroller is in said active mode; and
a fourth regulator receiving said external power supply voltage and supplying said high-power supply voltage at a fourth rated power less than said third rated power in response to said external power supply voltage when the microcontroller is in said low power mode,
wherein said controller activates all of said plurality of peripheral circuits in said active mode, and activates a subset of said plurality of peripheral circuits while keeping remaining ones of said plurality of peripheral circuits inactive in said low power mode.

11. The microcontroller of claim 10, wherein said controller transitions from said low power mode to said active mode in response to an input received by one of said remaining ones of said plurality of peripheral circuits while in said low power mode.

12. The microcontroller of claim 11, wherein:
said controller further includes a power monitor that activates a control signal when outputs of said first regulator, said second regulator, said third regulator, and said fourth regulator are within acceptable ranges; and
said controller transitions from said low power mode to said active mode further in response to said control signal.

13. The microcontroller of claim 10, wherein:
said third regulator comprises a low drop-out regulator; and
said fourth regulator comprises a regulated charge pump that supplies said high-power supply voltage using a corresponding replica branch.

14. The microcontroller of claim 10, wherein:
in response to detecting an idle event, said controller further controls a transition of the microcontroller between said active mode and an idle mode, wherein in said idle mode, said controller places said CPU core in a sleep mode, continues to power all of said plurality of peripheral circuits using said first regulator, and continues to power said CPU core and said memory using said second regulator.

15. The microcontroller of claim 8, wherein said controller transitions from said active mode to said low power mode in response to a setting of a low power bit in a control register.

16. The microcontroller of claim 8, wherein:
the microcontroller further comprises a flash non-volatile memory coupled to said CPU core, to said low-voltage power bus, and to a flash bus; and
said first regulator further supplies a flash power supply voltage to said flash bus in response to said external power supply voltage when the microcontroller is in said active mode.

17. A method of operating an integrated circuit, comprising:
in an active mode:
generating a first internal power supply voltage having a first nominal voltage on a first power supply voltage rail using a first voltage regulator; and
activating each of a first plurality of circuits coupled to said first power supply voltage rail, and
in a low power mode:
generating said first internal power supply voltage having said first nominal voltage on said first power supply voltage rail using a second voltage regulator, wherein said second voltage regulator has a lower rated power than said first voltage regulator; and
activating a subset of said first plurality of circuits while keeping remaining ones of said first plurality of circuits inactive.

18. The method of claim 17, further comprising:
in said active mode:
generating a second internal power supply voltage having a second nominal voltage on a second power supply voltage rail using a third voltage regulator; and
activating each of a second plurality of circuits coupled to said second power supply voltage rail, and
in said low power mode:
generating said second internal power supply voltage having said second nominal voltage on said second power supply voltage rail using a fourth voltage regulator, wherein said fourth voltage regulator has a lower rated power than said third voltage regulator; and
activating a subset of said second plurality of circuits while keeping remaining ones of said second plurality of circuits inactive.

19. The method of claim 17, wherein:
activating each of said first plurality of circuits comprises providing a respective clock signal to each of said first plurality of circuits;
activating said subset of said first plurality of circuits comprises providing a respective clock signal to each of said subset of said first plurality of circuits; and
keeping said remaining ones of said first plurality of circuits inactive comprises removing a clock signal from said remaining ones of said first plurality of circuits.

20. The method of claim 17, further comprising:
in said active mode:
generating a second internal power supply voltage having a second nominal voltage lower than said first nominal voltage on a second power supply voltage rail using a third voltage regulator; and
activating each of a second plurality of circuits coupled to said first power supply voltage rail, and
in said low power mode:
generating said second internal power supply voltage having said second nominal voltage on said second power supply voltage rail using a fourth voltage regulator, wherein said fourth voltage regulator has a lower rated power than said third voltage regulator; and
activating a subset of said second plurality of circuits while keeping remaining ones of said second plurality of circuits inactive.

21. A method of operating an integrated circuit, comprising:
activating a low-power bias circuit, a first high-voltage regulator, and a first low-voltage regulator when an external power supply voltage rises above a first level;
generating a low-power reference voltage using said low-power bias circuit;
generating a first internal power supply voltage on a first power supply voltage rail using said first high-voltage regulator in response to said low-power reference voltage and said external power supply voltage;
activating a subset of a first plurality of circuits coupled to said first power supply voltage rail while keeping remaining ones of said first plurality of circuits inactive;
generating a second internal power supply voltage on a second power supply voltage rail using said first low-voltage regulator in response to said low-power reference voltage and said external power supply voltage, said second internal power supply voltage lower than said first internal power supply voltage; and
activating a subset of a second plurality of circuits coupled to said second power supply voltage rail while keeping remaining ones of said second plurality of circuits inactive.

22. The method of claim 21, further comprising:
activating a high-power bias circuit, a second high-voltage regulator and a second low-voltage regulator when said external power supply voltage rises above a second level greater than said first level;
generating a high-power reference voltage using said high-power bias circuit in response to said first internal power supply voltage;
generating said first internal power supply voltage on said first power supply voltage rail using said first high-voltage regulator in response to said high-power reference voltage and said external power supply voltage;
activating said remaining ones of said first plurality of circuits;
generating said second internal power supply voltage using said second low-voltage regulator having a higher rated power than a rated power of said first low-voltage regulator in response to said high-power reference voltage and said external power supply voltage; and
activating said remaining ones of said second plurality of circuits.

23. The method of claim 22, further comprising:
detecting a low power event, and in response to detecting said low power event:
disabling said remaining ones of said first plurality of circuits;
disabling said remaining ones of said second plurality of circuits;
enabling said first high-voltage regulator (414);
enabling said first low-voltage regulator (417);
disabling said second high-voltage regulator;
disabling said second low-voltage regulator; and
entering a low power mode.

24. The method of claim 23, wherein detecting said low power event comprises:
detecting an activation of a low power bit in a control register.

25. The method of claim 23, further comprising:
detecting a wakeup event, and in response to detecting said wakeup event:
enabling said second high-voltage regulator;
enabling said second low-voltage regulator;
disabling said first high-voltage regulator;
disabling said first low-voltage regulator;
enabling said remaining ones of said first plurality of circuits;
enabling said remaining ones of said first plurality of circuits; and
entering an active mode.

26. The method of claim 25, wherein detecting said wakeup event comprises:
detecting an activation of a signal by said subset of said first plurality of circuits.

27. The method of claim 22, further comprising:
detecting an idle event, and in response to detecting said idle event:
placing a central processing unit (CPU) core in a sleep mode;
continuing to power all of said first plurality of circuits using said first high-voltage regulator;
continuing to power all of said second plurality of circuits using said first low-voltage regulator; and
entering an idle mode.

28. The method of claim 27, further comprising, in response to detecting said idle event but before entering said idle mode:
enabling a third high-voltage regulator having a replica branch to a flash power supply voltage rail coupled to a flash memory (450); and
disabling a fourth high-voltage regulator coupled to said flash power supply voltage rail.
